(19) United States
(12) Patent Application Publication
(10) Pub. No.: US 2011/0079588 A1
(43) Pub. Date: Apr. 7, 2011

(54) DEVICE FOR REMOVAL OF EXCESS EMBEDDING MEDIUM

(76) Inventors: Steffen Kraus, Wiesloch (DE); Erwin Schneider, Nussloch (DE)

(21) Appl. No.: 12/995,091

(22) PCT Filed: Apr. 21, 2009
(86) PCT No.: PCT/DE09/00515

§ 371 Date: Nov. 29, 2010

(30) Foreign Application Priority Data
May 29, 2008 (DE) 10 2008 025 787.7

(51) Int. Cl. H05B 3/00

(52) U.S. Cl. 219/201

(57) ABSTRACT

A device for removal of excess embedding media from the surface of an embedded sample, particularly for removing wax from the outside of a tissue cassette, comprising a rack (1) and a heatable plate (2) held at an incline by the rack (1), with grooves, flutes, recesses or the like serving as drainage channels (3) being configured in the surface of the plate (2) for receiving and discharging abraded and melted embedding medium and said channels flowing into a collection channel (4), characterized in that the drainage grooves (3) each open from a highest point down outwardly on either side into collection channels (4), which lead to a catch container (5).

The invention concerns a device for removal of excess embedding medium from the surface of an embedded sample, especially for removal of wax from the outside of a tissue cassette, with rack and a heatable plate, held at a slope from the rack, in which grooves, flutes, recesses or the like are formed in the surface of the plate as runoff chutes to receive and discharge abraded and melted embedding medium, which discharge into a collecting chute.

Devices of the generic type are used in pathology and histology, namely, during preparation of tissues or tissue samples for examinations. The tissue samples, after treatment, are embedded in an embedding medium, preferably in a so-called tissue cassette. The tissue sample can be handled by this expedient. Wax or paraffin, which is melted for this purpose, regularly serves for embedding.

For subsequent examination, for example, in the context of fluorescence microscopy, it is necessary that tissue samples or the cassette carrying the tissue sample can be perfectly and reproducibly positioned and adjusted. If paraffin residues are found on the embedded sample or on the tissue cassette, adjustment and perfect positioning of the tissue sample are not possible. Consequently, it is necessary to remove excess embedding medium before actual examination, in order to be able to rule out incorrect positioning of the tissue sample.

A generic device, with which excess embedding medium can be removed from the surface of an embedded sample, especially the outside of a tissue cassette, is known from WO 2002/023157 A2. The known device includes a rack, by which a heatable plate is held in a sloped or oblique position. The plate includes a structured surface, namely, a surface equipped with grooves, flutes, recesses or the like, according to which several parallel drainage chutes are formed. The drainage chutes run obliquely on the plate surface, namely, downward in the direction of the slope produced by the oblique positioning of the plate, so that stripped off wax melts by heating of the plate and flows by gravity in the drainage chutes to an edge area of the plate. A collecting chute is found there, into which all the drainage chutes discharge. From there, the removed wax can drip into a correspondingly positioned tray, which, however, is not provided in the device.

The device known from WO 2002/023157 A2 is problematical to the extent that it is always necessary to collect the wax draining off via the drainage chutes and collecting chute in a separate container. This container must always be positioned relative to the device. This is irksome.

In addition, the molten wax can drain off exclusively in one direction, namely, in the direction of the sloped flutes, so that precisely during removal of large amounts of wax or during simultaneous treatment of several tissue samples, overfilling of the drainage chutes and backup and therefore overflow can occur. If tissue samples are further treated, the excess wax is regularly smeared on the surface of the plate and can, at best, be taken off with a significant time delay. The processing operation is hampered on this account.

Another shortcoming in the generic device is that the drainage chutes are sloped in one direction, so that scraping off of the embedded sample or tissue cassette can only occur in one direction, namely, across the drainage chutes. Consequently, the known device is always suited for just right-handed or left-handed persons and cannot be used in both movement directions for movement of the sample or tissue cassette.

The underlying task of the present invention is to configure and modify a device of the generic type, so that even larger amounts of excess embedding medium can be removed with sufficient operational reliability without effort, without having to perform clumsy positioning of the trapping vessels.

The aforementioned task is solved according to the invention by a device with the features of claim 1. According to it, the generic device is characterized by the fact that the drainage chutes discharge into collecting chutes on both sides, dropping off outward from the highest point and leading to a trapping vessel.

It was recognized according to the invention that the device can be used in different directions for the scraping off movement of the sample or tissue cassette, if the grooves are designed dropping off outward from the highest point on both sides. Consequently, the grooves, starting from an imaginary center line, are designed to drop off to the left and right, so that the sample or tissue cassette can be guided obliquely relative to the groove at different angles. Consequently, the device is suitable for right-handed and left-handed persons, namely, for movement of the sample in two different directions.

It is also a particular advantage that the grooves discharge on both sides, dropping off outward into collecting chutes, namely, collecting chutes arranged on both sides of the grooves and enclosing them. The collecting chutes lead to a trapping vessel, which is allocated to the device. It is therefore guaranteed that scraped off and melting embedding medium collects via the drainage chutes in the collecting chute and from there runs or drips into the trapping vessel. Special measures to trap the scraped off and melting embedding medium are not necessary.

Drainage chutes are advantageously designed symmetric with equally long drainage arms on both sides, in which an asymmetric embodiment with drainage arms of different length on both sides is also possible. A symmetric embodiment has the advantage that the embedded sample or tissue cassette can be freed from embedding medium from two directions with sufficiently good effect, since the arrangement of the drainage chutes essentially permits two movement directions for stripping off of the embedding medium.

It is also an advantage, if several drainage chutes are arranged one beneath the other over the length of the plate, so that multiple stripping is possible. The arrangement of several drainage chutes also has the advantage that several samples or tissue cassettes can be simultaneously moved over the plate.

The drainage chutes can run parallel to each other. It is also conceivable that the drainage chutes diverge or converge fan-like. Such an arrangement has the advantage that small samples can be stripped off in the area of drainage chutes lying close to each other and larger samples can be stripped off in the area of drainage chutes lying farther from each other.

As already stated, the drainage chutes discharge on both sides into a collecting chute and therefore form a communicating chute system with the collecting chutes. This guarantees that the stripped off embedding medium, which runs along the drainage chutes in the molten state, reaches the trapping vessel via the collecting chutes. It must then be guaranteed that the plate has a more or less uniform temperature over the entire chute system, in which the embedding medium is sufficiently fluid, in order to move along the gradient through the chute system.

With quite particular advantage the collecting chutes discharge close to the lowest part of the plate or directly at a lowest part of the plate in a drip area situated above the trapping vessel. The drip area includes a recess in the plate, into which the collecting chutes discharge, or in which the collecting chutes open. The drip area can include a downward directed drip tab or the like, so that the embedding medium is guided deliberately into the trapping vessel situated beneath it.

It should be mentioned with reference to the drainage chutes that, on the one hand, they serve for stripping off of the excess embedding medium and, on the other hand, for drainage of the stripped off and melted embedding medium. It is then advantageous, if the edges of the drainage chutes are designed sharp-edged, so that the excess embedding medium can be effectively stripped off.

The bottom or groove base of the drainage chutes and optionally the collecting chutes is preferably rounded off, in order to favor drainage of the melted embedding medium. In each case, capillary effects that hamper flow of the embedding medium should be avoided in the corner areas of the chute system.

It is also conceivable that the surfaces between the drainage chutes, namely, the surfaces of the plates situated between the drainage chutes, are at least slightly sloped relative to each other, so that one edge of the drainage chute is always raised relative to the other edge. In a correspondingly sharp-edged embodiment, the abrasive effect of stripping off on the raised edge is favored by this expedient.

It was also already mentioned that the plate is heated. It is then essential that the plate temperature be maintained, during which the embedding medium, for example, wax or paraffin, can flow relatively fluid in the chute system along the gradient. Temperatures in the range between 50° C. and 60° C. should then be achieved on the surface of the plate. Advantageously, an electrical heating device with at least one heating element is assigned to the rack for this purpose. The heating element can be assigned directly to the plate, preferably on its bottom.

In principle, it is conceivable that the heating element is integrated in the plate or designed as a plate. In other words, the heating element could be designed in the sense of a heating plate and therefore represent the plate itself or be firmly connected to it beneath the plate. An adhesive joint of a heating plate with the actual plate is conceivable.

In any case, it is essential that a sufficiently good heat transfer be achieved between the heating plate or heating conductors and the plate.

With reference to the plate, it is advantageous, if it can be removed from the rack, namely, on the one hand, for cleaning and, on the other hand, for replacement with another plate. Accordingly, it is advantageous, if the plate is inserted or plugged into the rack. In any case, the plate should be releasably connected to the rack. In the case of a ferromagnetic embodiment of the plate, it is conceivable that the plate is joined to the rack via magnetic forces. Such a joint is also possible by allocating a magnetic strip to the plate in the edge area.

The heating element assigned to the plate must be contacted electrically. For this purpose, at least one plug connection can be provided for fastening of the plate, which includes an electrical connection for the heating device. Mechanical and electrical coupling of the plate could therefore be accomplished by the same measure.

With further advantage, the heating device includes a control or regulation for the plate temperature. It must then be guaranteed that the plate can be kept at a constant outside temperature, in order to be able to guarantee reliable operation of the device also over a longer period. It is also advantageous, if stipulated temperatures can be set or selected. The plate is advantageously made from metal. Making the plate from aluminum or an aluminum alloy is a workable solution. Production by injection molding or die casting is possible. It is also conceivable to machine the plate from a solid.

At least two plates with different surface structure are also advantageously provided for exchange, so that it is possible to adjust the device to the specific requirement, namely, to provide different surface structures.

The trapping vessel is situated beneath the lowest point of the pate and advantageously extends at least slightly into the rack. The trapping vessel could then be designed as a completely removable drawer, so that isolated cleaning of the drawer is possible.

With reference to the required oblique position of the plate, it is advantageous, if the rack be designed wedge-like, so that the chute system is particularly suitable for drainage of the molten embedding medium according to the slope of the rack.

It is specifically advantageous, if the rack if designed as a housing with an opening on the front for insertion of the trapping vessel. The trapping vessel can be made of plastic, but also from the same material as the plate. The housing is also made of aluminum or aluminum alloy with advantage. The plate can serve as a cover of the housing, so that it closes off the housing on the top. The required electrical/electronic devices are situated within the housing, especially the heating device and its control/regulation.

The housing is also closed from the bottom, namely, by a bottom plate screwed on from below. Four rubber pads, as anti-slip feet, can be provided with the screw connection.

There are now different possibilities of configuring and further modifying the instructions of the present invention advantageously. For this purpose, on the one hand, the claims subordinate to claim 1 and, on the other hand, the following explanation of a practical example of the invention with reference to the drawings, are referred to. In conjunction with the explanation of the preferred practical example of the invention by means of the drawings, generally preferred embodiments and modifications of the instructions were also explained. In the drawings

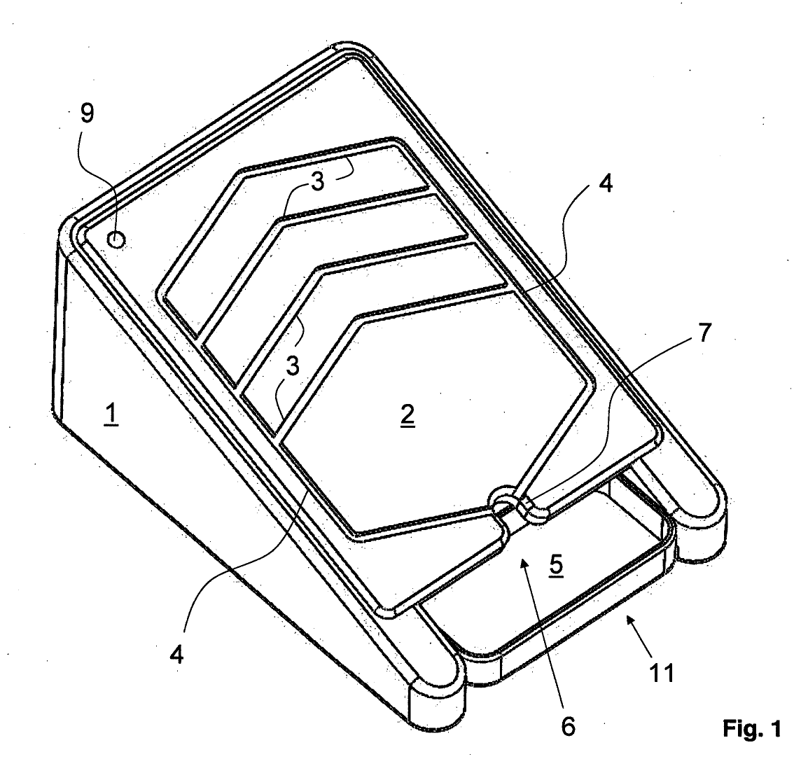

FIG. 1 shows a schematic view of a practical example of the device at obliquely from the front,

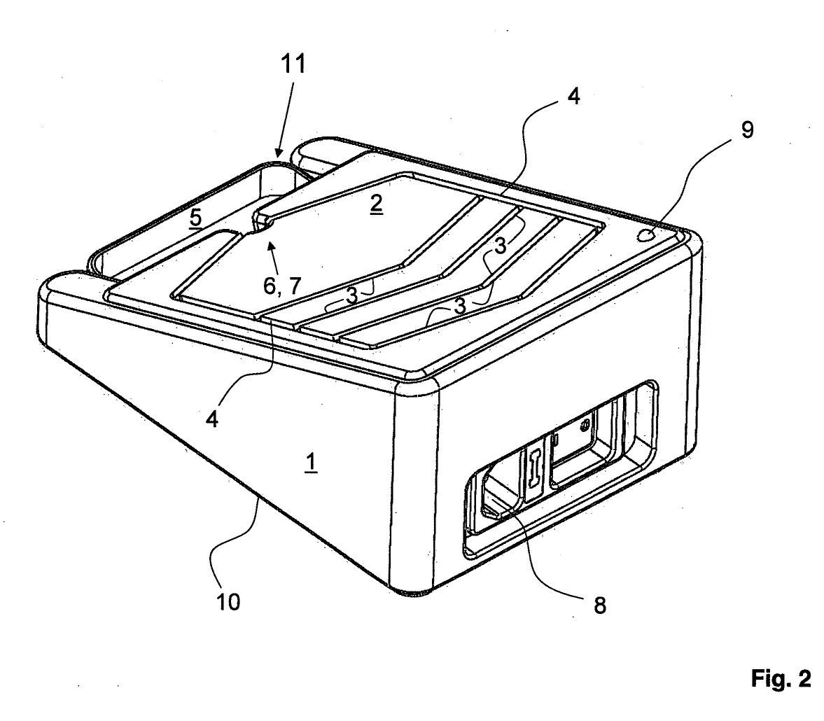

FIG. 2 shows a schematic view of the object from FIG. 1 obliquely from the rear,

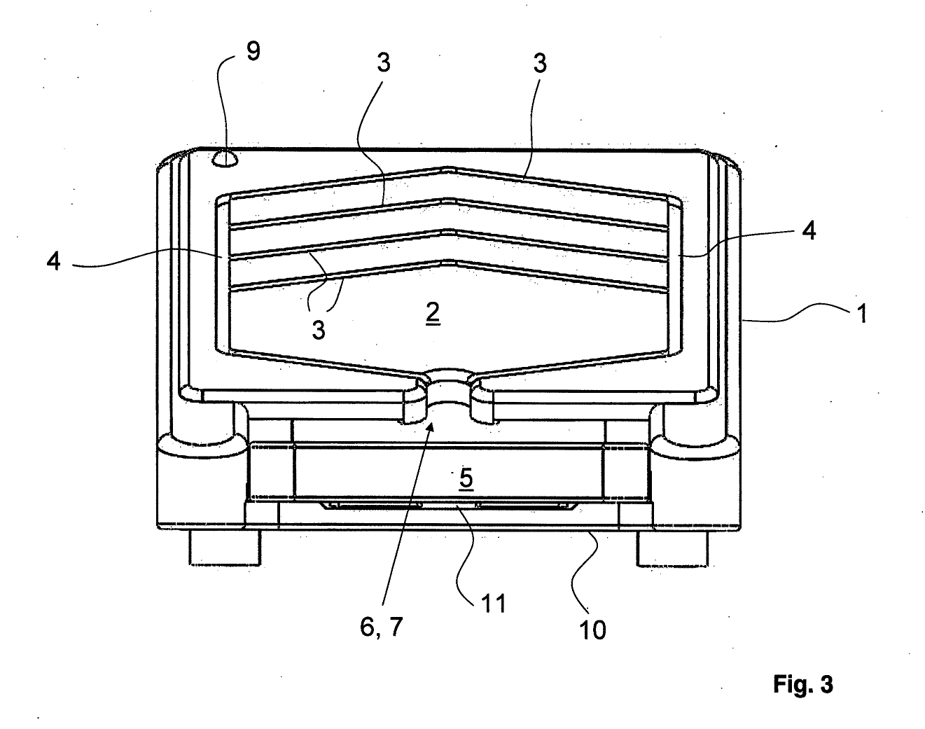

FIG. 3 shows a schematic view of the object from FIG. 1 from the front, and

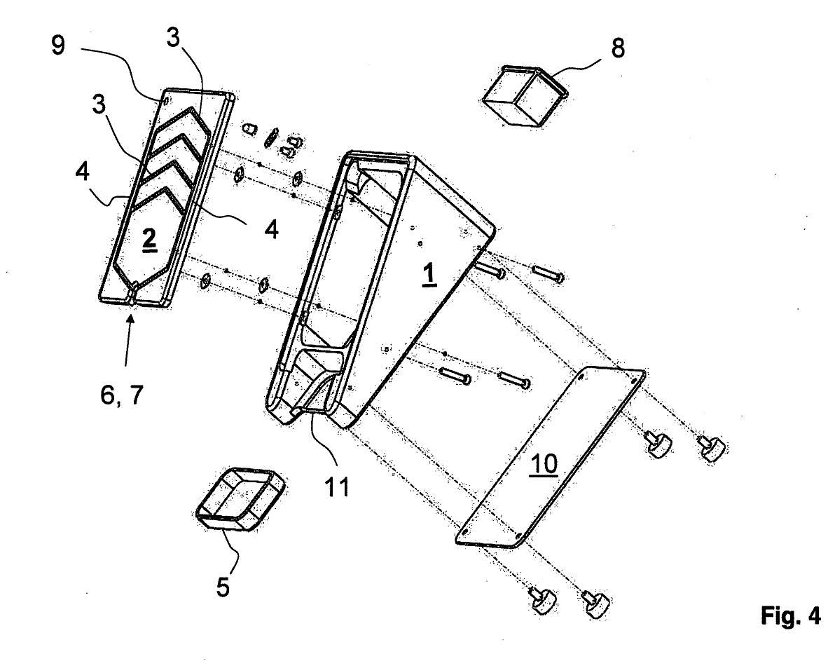

FIG. 4 shows an exploded view of individual components of the device according to FIG. 1 to 3.

FIG. 1 to 4 show a practical example of a device according to the invention for removal of excess embedding medium from the surface of an embedded sample, in which the embedding medium is regularly wax or paraffin. Ordinarily, it is a question of removing excess paraffin from the outside of a tissue cassette, in which a tissue sample is embedded.

The device includes a rack 1 designed as a housing and a plate 2 held by the housing 1 with a slope. Plate 2 is heated from the bottom. On the one hand, it serves for stripping off of excess embedding medium and, on the other hand, for liquefaction of the medium, so that it can drain over the plate. Specifically, drainage chutes 3 in the form of grooves are formed in the surface of plate 2, which serve to receive and divert the abraded and molten embedding medium. The drainage chutes 3 discharge into lateral collecting chutes 4.

According to the invention, the drainage chutes 3 are designed, so that they discharge into the collecting chutes 4, dropping off outward on both sides from the highest point. Accordingly, the drainage chutes 3 are V-shaped, dropping off downward, in which the collecting chutes 4 lead to a trapping vessel 5.

In the practical example shown in the figures, the drainage chutes 3 are designed symmetric with equally long drainage arms on both sides. Four identical drainage chutes 3, having identical spacing from each other and running parallel, are also situated one beneath the other. The drainage chutes 3, together with the lateral collecting chutes 4, form a communicating chute system, which serves, on the one hand, to strip off the excess embedding medium and, on the other hand, to liquefy and drain off the stripped off embedding medium.

The figures also show that the collecting chutes 4 discharge close to the lowest point of the plate 2 in a drip area 6 above the trapping vessel 5. Specifically, the drip area 6 includes a recess 7 in plate 2, into which the collecting chutes 4 discharge.

The edges of the drainage chutes 3 are designed sharp-edged to favor stripping. The groove base is rounded off, so that discharge of liquid paraffin is guaranteed.

Plate 2 is electrically heated. Specifically, a heating plate, the component of an integrated heating device, is situated on the bottom of plate 2.

FIG. 2 shows the electrically connection 8 for the heating device, in which an instrument plug (not shown in the figure) can be inserted. A control light 9 indicates whether the device is switched on. It is possible via corresponding diodes to display the operating state or the switched on state with one color and the achievement of operating temperature with another color. The provision of several control lights 9 is conceivable.

The figure also shows that the plate 2 is inserted into the rack I designed as a housing and locked there. It is possible, for example, to screw the plate 2 from the bottom firmly to rack 1.

The figures also clearly show the trapping vessel 5, which is designed as a drawer and is inserted into a lower area of the rack 1 or housing. The trapping vessel 5 is situated directly beneath the drip area 6 and the recess 7 forming the drip area 6, so that the embedding medium, flowing by gravity in the chute system, can drip into the trapping vessel 5. A simple removal and cleaning of the trapping vessel 5 is guaranteed, because of the chosen design is a drawer.

Both the plate 2 and the rack 1 or housing can be made from aluminum. The rack 1 can then be made in one piece, in which the plate 2 closes off the rack 1 or housing from the top and a bottom plate 10, only shown in FIG. 4, closes off the rack 1 or housing from the bottom. The shelf, serving to accommodate the trapping vessel 5, is bounded inward according to the dimensions of the trapping vessel 5, so that the internal space of the rack 1 or housing is completely closed off.

With reference to the features that cannot be deduced from the figure, the general part of the description is referred to, to avoid repetitions.

It should finally be noted that the practical example just explained serves merely to explain the device according to the invention, but does not restrict it to the practical example.

### LIST OF REFERENCE NUMBERS

1 Rack

2 Plate

3 Drainage chutes

4 Collecting chutes

5 Trapping vessel, drawer

6 Drip area

7 Recess

8 Electrical connection

9 Control element

10 Bottom plate

11 Shelf (for drawer)

1.-29. (canceled)

30. A device for removal of excess embedding medium from the surface of an embedded sample, especially for removal of wax from the outside of a tissue cassette, said device comprising:
a rack and a heatable plate, held by the rack with a slope, in which grooves, flutes, recesses or the like, serving as drainage chutes, are formed in the surface of the plate to receive and divert abraded and molten embedding medium, which discharge into one or more collecting chutes,
wherein the drainage chutes discharge from the highest point in the collecting chutes, dropping off outward on both sides, which lead to a trapping vessel.

31. The device according to claim 30, wherein the drainage chutes are designed symmetric with equally long drainage arms on both sides.

32. The device according to claim 30, wherein the drainage chutes are designed asymmetric with drainage arms of different length on both sides.

33. The device according to claim 30, wherein several drainage chutes are arranged one beneath the other over the length of plate.

34. The device according to claim 30, wherein drainage chutes run parallel to each other.

35. The device according to claim 30, wherein the drainage chutes, together with the collecting chutes, form a communicating chute system.

36. The device according to claim 30, wherein the collecting chutes discharge in a drip area above the trapping vessel close to or at the lowest point of the plate.

37. The device according to claim 36, wherein the drip area includes a recess in the plate, into which the collecting chutes discharge.

38. The device according to claim 30, wherein the edges of the discharge chutes are designed sharp-edged.

39. The device according to claim 30, wherein a groove base of the discharge chutes and optionally the collecting chutes is rounded.

40. The device according to claim 30, wherein the surfaces between the drainage chutes are at least slightly sloped relative to each other.

41. The device according to claim 30, wherein an electrical heating device with at least one heating element is allocated to the rack.

42. The device according to claim 41, wherein the heating element is allocated directly to the plate, preferably on its bottom.

43. The device according to claim 41, wherein the heating element is designed as a heating plate.

44. The device according to claim 41, wherein the heating element is integrated in the plate or designed as the plate.

45. The device according to claim 30, wherein the plate is introduced or inserted into the rack.

46. The device according to claim 30, wherein the plate is releasably connected to the rack.

47. The device according to claim 46, wherein the plate is connected to the rack via magnetic forces.

48. The device according to claim 41, wherein at least one plug connection is provided for fastening of the plate, which includes an electrical connection for the heating device.

49. The device according to claim 41, wherein the heating device includes a control or regulation for a temperature of the plate.

50. The device according to claim 30, wherein the plate is made from metal.

51. The device according to claim 50, wherein the plate is made from aluminum or an aluminum alloy.

52. The device according to claim 30, wherein at least two plates with different surface structure are provided for a replacement.

53. The device according to claim 30, wherein the trapping vessel extends into the rack beneath the plate.

54. The device according to claim 53, wherein the trapping vessel is designed as a completely removable drawer.

55. The device according to claim 30, wherein the rack is designed wedgelike.

56. The device according to claim 30, wherein the rack is designed as a housing with an opening on a front for the trapping vessel.

57. The device according to claim 30, wherein the plate serves as a cover of the housing.

58. The device according to claim 30, wherein the housing is closed on the bottom by a bottom plate.
